(19) United States
(12) Patent Application Publication
(10) Pub. No.: US 2007/0097668 A1
(43) Pub. Date: May 3, 2007

(54) Self-generating type light emitting device for helmet

(75) Inventor: Young-Wook Choi, Euijungbu-si (KR)

Correspondence Address: R. Neil Sudol, 714 Colorado Avenue, Bridgeport, CT, 06605-1601, US

(73) Assignee: HJC Co., LTD, Youngin-si (KR)

(21) Appl. No.: 11/314,970

(22) Filed: Dec. 21, 2005

(30) Foreign Application Priority Data
Oct. 28, 2005 (KR) 2005-0102180

(51) Int. Cl. F21V 21/084; F21L 13/02; F21V 33/00

(52) U.S. Cl. 362/105; 362/192; 362/96

(57) ABSTRACT

A self-generating type light emitting device for helmet, in which a small generator is operated by wind power generated during driving, the electricity generated by this generator lights light-emitting diodes fitted on the helmet so as to enhance driving safety and impart a decorative effect, is disclosed. The self-generating type light emitting device for a helmet comprises a case 20 having a mounting portion 21, and a protruding portion 22 to provide a predetermined mounting space inside of the case 20; an electricity generating means 30 having a generator 33 fixed by a bracket 34 on the inside of the protruding portion 21 of the case 20, and a rotary blade 31 fixed at the front end of the shaft 32 of the generator 33; and a light-emitting means 40 having a plurality of light-emitting lamps 41 which are lighted by electricity generated from the generator 33.

### BACKGROUND OF THE INVENTION

1. Field of the Invention

The present invention relates to a self-generating type light emitting device for a helmet, and more specifically to a self-generating type light emitting device for a helmet in which a small generator is operated by wind power generated during driving and the electricity generated by this small generator lights light-emitting diodes fitted on the helmet so as to improve driving safety and impart a decorative effect.

2. Description of the Related Art

In general, a helmet for motorcycle or bicycle is a safety outfit for protecting the head portion of the wearer when an accident happens. In order to enhance external identifiability when driving on the road in cloudy daytime or dark nighttime, a luminous recognition tag or a light-emitting body is attached on the surface of the helmet.

Compared with attaching a luminous or primary-color recognition tag, installing a light emitting device further enhances external identifiability during nighttime driving so it is possible to provide the wearer with driving safety to a certain degree. However, a conventional light emitting device for a helmet needs a battery for supplying electricity to the light-emitting diode, and the battery should be replaced periodically to drive for a long time.

Namely, the battery for supplying power has a given lifetime, so it has to be replaced frequently, and if the replacement time of the battery is missed, the light-emitting diode will not be lighted, so it cannot emit light. Also, since it is bothersome to replace batteries and it costs a lot to purchase them, they are left alone without being used, so there is a problem that safety cannot be secured during nighttime driving.

### SUMMARY OF THE INVENTION

Therefore, it is an object of the present invention to provide a self-generating type light emitting device for a helmet in which a self-generator by wind power is provided to supply electricity without replacing batteries even if it is used for a long time so that the cost of purchasing batteries is reduced and emission interruption due to electric discharge is prevented.

Another object of the present invention is to provide a self-generating light emitting device for a helmet in which the attachment surface of the case having a self-generator and light-emitting means is configured as correspond to the external curved surface of the helmet so that it is possible to identify the helmet more easily from behind even during daytime driving and make the overall appearance of the helmet beautiful.

In accordance with the present invention, there is provided a self-generating type light emitting device for a helmet comprising: a case having a mounting portion with a shape corresponding to the external surface of the helmet and a protruding portion which is protruded upward from the mounting portion to provide a predetermined mounting space inside of the case and in which are formed an air inlet for air to be introduced in and a plurality of air outlets for the introduced air to be discharged; an electricity generating means having a generator fixed by a bracket on the inside of the protruding portion of the case, and a rotary blade fixed at the front end of the shaft of the generator and rotated by air introduced through the air inlet; and a light-emitting means having a plurality of light-emitting lamps which are lighted by electricity generated from the generator and supplied through wire, and are fixed such that part of them are exposed on the surface of the case.

Preferably, The device further comprises a guide portion formed in the air inlet of the case for guiding the introduced air to direct toward the rotary blade.

### BRIEF DESCRIPTION OF DRAWINGS

Other objects and aspects of the present invention will become apparent from the following description of embodiments with reference to the accompanying drawings in which:

FIG. 1 is a perspective view of a self-generating type light emitting device according to the present invention;

FIG. 2 is a longitudinal cross-sectional view showing the self-generating type light emitting device according to the present invention;

FIG. 3 is a bottom view showing the self-generating type light emitting device according to the present invention;

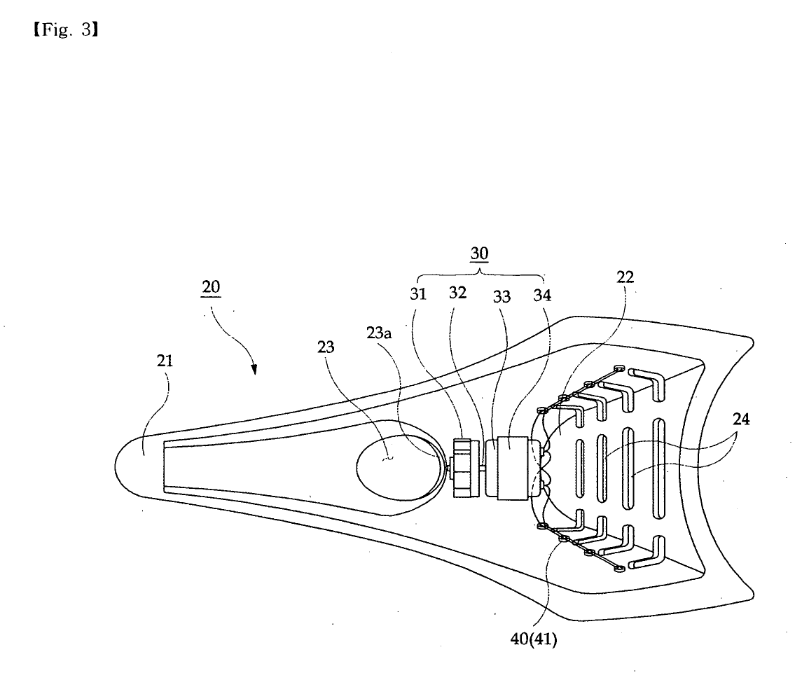

FIG. 4 is a lateral view showing how the self-generating type light emitting device according to the present invention is fitted on a helmet.

### DESCRIPTION OF THE PREFERRED EMBODIMENT

Below will be described in detail a self-generating type light emitting device for a helmet according to an preferred embodiment of the present invention with reference to accompanying drawings.

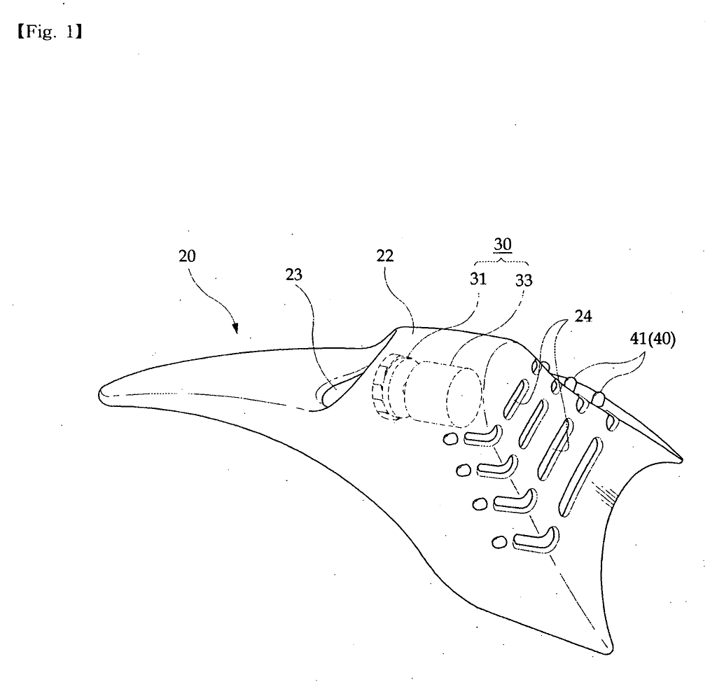

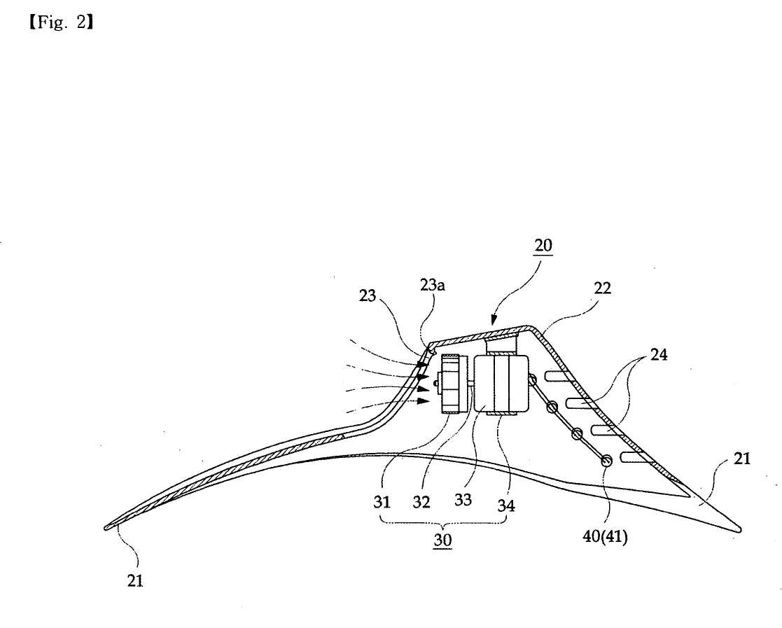

FIGS. 1 and 2 are a perspective view and a longitudinal cross-sectional view showing the structure of the self-generating type light emitting device for a helmet according to the present invention.

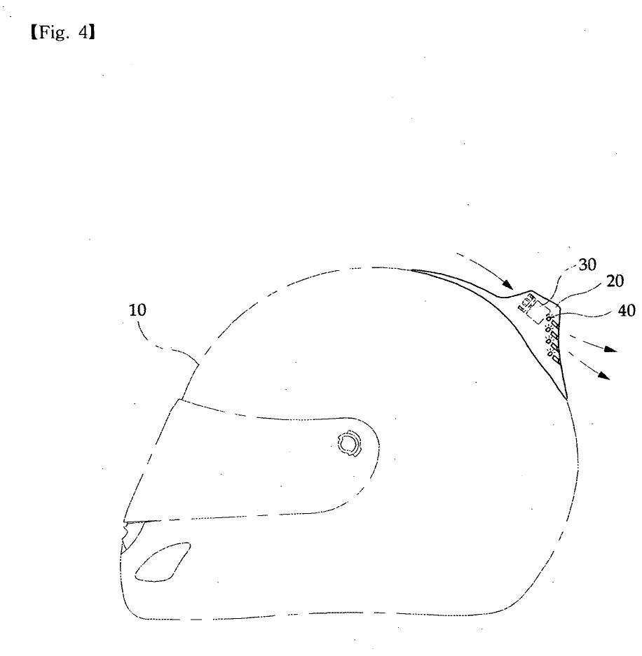

As shown in these drawings, the self-generating type light emitting device of the present invention comprises a case 20 fixed on the external surface of a conventional helmet 10 (FIG. 4), a generator 33 provided inside the case 20 as an electricity generating means 30, and a plurality of light-emitting lamps 41 as light-emitting means 40 that are lighted by electricity generated by the generator 33.

Here, the generator 33 that self-generates electricity by wind power is installed inside the case 20 by a bracket 34, and a rotary blade 31 is mounted on the front end of a shaft 32 of the generator 33. Electricity generated by rotation of the rotary blade 31 is supplied to the light-emitting lamps 41 to make light emission.

The case 20 is attached on the external surface of the helmet 10, and it is preferable that the attachment surface (the bottom surface in the drawing) has a shape that corresponds to the external curved surface of the helmet to enhance adherence. This case 20 comprises a mounting portion 21 which has a shape corresponding to the external curved surface of the helmet and a protruding portion 22 which protrudes upward from the mounting portion 21 to provide a predetermined mounting space. On the front of the protruding portion 22 is formed an air inlet 23 opened toward the front of the helmet, and on the back are formed a plurality of air outlets 24 which discharge toward the back the air that was introduced from the air inlet 23.

In the present detailed description, the front refers to the direction in which a bicycle or motorcycle moves forward when driving with the helmet on and the back refers to the opposite direction.

Also, a guide 23a is formed in the air inlet 23 for guiding the air introduced from the front to the rotary blade 31 of the generator 33 during driving. Preferably, the guide 23a, in the process of guiding the direction of the wind introduced through the air inlet 23 toward the rotary blade 31, should improve the durability of the rotary blade 31 by making the wind flow toward the center of the rotary blade 31.

And, as a method for attaching the case 20 on the external surface of the helmet 10, it is preferable to apply an adhesive agent on the mounting portion 21 of the case 20 to adhere it semi-permanently with the external surface of the helmet 10. Another method is to mount the case 20 on the helmet 10 only when necessary by attaching adhesion means such as Velcro Fastener™ on the mounting portion 21 and the external surface of the helmet 10, respectively.

As mentioned above, the wind-power type self-generating means 30 adopted in the present inventions comprises a generator 33 which generates electricity by the rotation of the shaft 32 of the generator 33, a rotary blade 31 fixed at the front end of the shaft 32 of the generator 33 to generate electricity while being rotated by air introduced through an inlet 23 of the case 20, and a bracket 34 for fixing the generator 33 on the inside of the protruding portion 22 of the case 20.

Therefore, as shown in FIG. 2, when the user drives a bicycle or motorcycle forward with a helmet 10 on, the air introduced into the case 20 through the air inlet 23 runs into the rotary blade 31 to rotate it. If the rotary blade 31 rotates, the shaft 32 of the generator 33 fixed on the rotary blade 31 is rotated together. Meanwhile, on the shaft 32 of the portion fitted in the generator 33 is fitted a conventional rotor (not shown) and on the inside of the generator 33 is fixed a conventional stator (not shown). Therefore, when the rotor rotates according as the shaft 32 of the generator 33 rotates, electricity is generated on the coil composing the stator (not shown) by the relative motion with the stator fixed on the inner wall of the generator 33, and the generated electricity is transmitted to light-emitting lamps 41 through wire via a conventional slip ring (not shown) and brush (not shown). These light-emitting lamps 41 are fixed such that parts of them are exposed on the outside of the case 20.

And, the light-emitting means 40 of the present invention comprises a plurality of light-emitting lamps 41, as shown in FIGS. 1 and 2. The light-emitting means 40 can be composed of a plurality of less power consuming light-emitting diodes, and in this case, it is preferable that it is composed of in such a way that sufficient emission can be made with the electricity generated from the generator 33 alone.

Meanwhile, in the case that light-emitting diodes 41 are used as a light-emitting means 40, external recognizability can be improved by making flashing timing different. At this time, a circuit and printed circuit board are used to control the charge of electricity supplied from the generator 33 and the flashing timing of light-emitting diodes 41.

Since such processes of electric generation and control of light-emitting diodes are arts in public domain already known in this technical field, detailed description of them are omitted.

The case 20 may be configured in such a structure that the self-generating type light emitting device of the present invention can be easily mounted according to the use of the helmet 10. Namely, when the shape of the case 20 attached to the external surface of the helmet 10 is designed, the mounting portion 21 of the case 20 may be configured according to the shape of the exterior shape of the helmet 10 for motorcycle or bicycle, for example, so as to enhance the adherence with the helmet. After all, it is possible to configure the shape of the case 20 variously to fit various helmets according to the use.

Thus, it is possible to improve the overall exterior appearance of the helmet 10 by fabricating the case 20 in the shape becoming to the helmet 10 according to the use.

As described above in detail, the present invention is provided with the electricity generating means 30 by wind power and also the guide 23a is formed in the air inlet 23 of the case 20, so it is possible to maintain the wind flow direction always at a constant rate and improve the durability of the rotary blade 31.

And, by adopting the electricity generating means 30 operated by wind power and the light-emitting means 40 lighted by the electricity generated by the generating means, it is possible to reduce the battery purchase cost and prevent interruption of light emission due to the battery discharge.

Also, by configuring the case 20 in a shape corresponding to the external surface of the helmet 10, it is easy to identify from behind after the helmet 10 is worn and it is also possible to get a decorative effect of improving the exterior appearance.

The aforementioned self-generating light emission device of the present invention is described as the one mounted on the helmet for bicycle or motorcycle, but those skilled in the art can understand the self-generating light emission device can be fitted on various devices other than the helmet. For example, the self-generating light emission device of the present invention may be fitted on a helmet for inline skate or ski for the safety of users.

Although the present invention has been described in connection with the exemplary embodiment illustrated in the drawings, it is only illustrative. It will be understood by those skilled in the art that various modifications and equivalents can be made to the present invention. Therefore, the true technical scope of the present invention should be defined by the appended claims.

What is claimed is:

1. A self-generating type light emitting device for a helmet comprising:
a case having a mounting portion with a shape corresponding to the external surface of the helmet and a protruding portion which is protruded upward from said mounting portion to provide a predetermined mounting space inside of the case and in which are formed an air inlet for air to be introduced in and a plurality of air outlets for the introduced air to be discharged;
an electricity generating means having a generator fixed by a bracket on the inside of the protruding portion of said case, and a rotary blade fixed at the front end of the shaft of said generator and rotated by air introduced through the air inlet; and
a light-emitting means having a plurality of light-emitting lamps which are lighted by electricity generated from said generator and supplied through wire, and are fixed such that part of them are exposed on the surface of said case.

2. The device according to claim 1, further comprising a guide portion formed in the air inlet of said case for guiding the introduced air to direct toward the rotary blade.
